(19) United States
(12) Patent Application Publication
(10) Pub. No.: US 2009/0066916 A1
(43) Pub. Date: Mar. 12, 2009

(54) SCANNING LASER PROJECTOR WITH REDUCED LASER POWER INCIDENT ON THE RETINA

(75) Inventor: Margaret K. Brown, Seattle, WA (US)

Correspondence Address: MICROVISION, INC., 6222 185TH AVENUE NE, REDMOND, WA, 98052, US

(73) Assignee: MICROVISION, INC., Redmond, WA (US)

(21) Appl. No.: 11/851,285

(22) Filed: Sep. 6, 2007

(51) Int. Cl. G03B 21/28; G03B 21/20

(52) U.S. Cl. 353/31; 353/121; 353/85

(57) ABSTRACT

A scanning laser projector projects multiple laser beams. The multiple laser beams have angular offsets relative to each other to separate the spots created by the laser beams on a projection surface. The angular offsets are set based on the desired spacing between the spots. Parameters within a video processing path are set to allow different pixel data to be simultaneously processed for each of the projected laser beams.

### FIELD

The present invention relates generally to scanning projectors, and more specifically to scanning laser projectors.

### BACKGROUND

Scanning laser projectors project laser light beams in a pattern to display an image. When laser light beams enter a human eye, heating and ablation may occur, resulting in tissue damage. Color scanning laser projectors may project more than one laser light beam to display a color image. The increased number of laser light beams increases the possibility of tissue damage if the laser beams enter the eye.

### BRIEF DESCRIPTION OF THE DRAWINGS

FIG. 1 shows a color micro-projector with angular offsets between color laser beams;

FIG. 2 shows scan trajectories for color laser beams in a scanning laser projector;

FIG. 3 shows a relationship between angular offsets and the size of a human eye;

FIG. 4 shows a projection device capable of processing display information for color laser beams having angular offsets;

FIG. 5 shows a mobile device in accordance with various embodiments of the present invention; and

FIG. 6 shows a flowchart in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

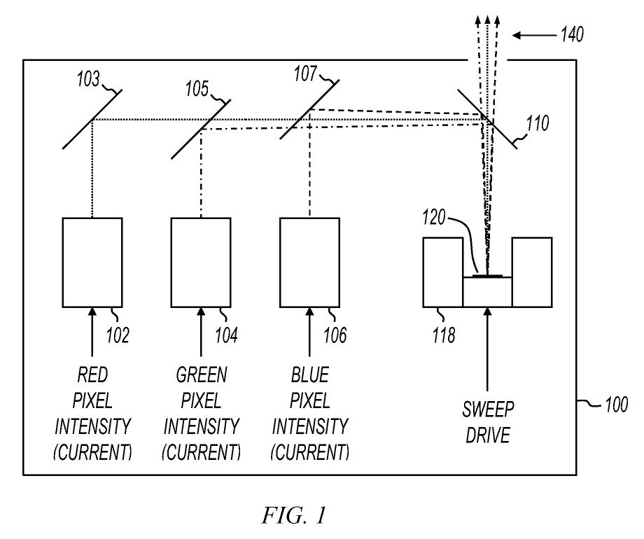

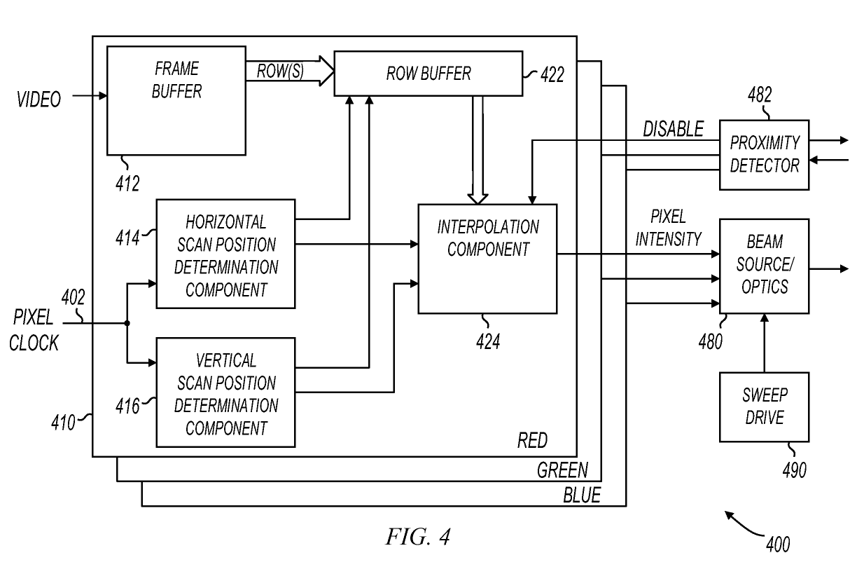

FIG. 1 shows a micro-projector. Projector 100 includes laser diodes 102, 104, and 106. Projector 100 also includes mirrors 103, 105, and 107, filter/polarizer 110, and Micro-Electro-Mechanical System (MEMS) device 118 having scanning mirror 120. The laser diodes are driven by red, green, and blue intensity data (current). Video processing circuitry to supply the intensity data is described below with reference to FIG. 4. Red, green, and blue light is provided by the laser diodes, although other light sources, such as color filters or light emitting diodes (LEDs) or edge-emitting LEDs, may be substituted. Laser light is produced by the laser diodes as a column, and these columns emerge as narrow beams. The beams are directed to the MEMS mirror (either directly or through guiding optics), and the beams emerge from an aperture at 140.

In some embodiments, the MEMS mirror is a biaxial mirror that rotates on two axes to sweep the light beams in both horizontal and vertical directions. In other embodiments, the MEMS mirror includes two separate mirrors, each rotating on one axis. The trajectory that the beam takes is a function of the signals received from the sweep drive. In some embodiments, the beams may sweep back and forth horizontally in a sinusoidal pattern. Further, in some embodiments, the beam may sweep up and down vertically in a sinusoidal pattern. In general, the beam may be swept in any combination of horizontal and vertical patterns, including linear and non-linear patterns. Pixels may be displayed when the beam is sweeping in one direction or in both directions. For example, in some embodiments, pixels may be displayed as the beam sweeps down in the vertical direction, but not when the beam sweeps back up. Also for example, in some embodiments, pixels may be displayed as the beam sweeps down as well as when the beam sweeps up in the vertical direction.

This process of picture-building can be repeated many times per second, to reproduce moving pictures. Therefore, a MEMS mirror and three colored light sources can function like a traditional CRT monitor or television set, but without the metal and glass vacuum tube, and without the phosphors on a screen. Instead, this produces a small projector, with a nearly infinite focal point.

Micro-projector 100 is shown with a housing having an aperture through which the color laser beams pass at 140. In some embodiments, the projector may be a stand alone device, and the aperture is an opening in the projector housing itself. In other embodiments, the projector is embedded in a larger device, and the aperture is in a housing for the larger device. For example, in some embodiments, the projector may be embedded in a handheld device such as a cell phone, and the aperture may be in the cell phone housing. The aperture may be an opening with or without a cover. For example, the aperture may include a transparent cover to pass light and keep out contaminants.

In the example of FIG. 1, laser diode 102 produces red light, and the red light is steered out the aperture by a first optics system. The first optics system includes mirror 103, filter/polarizer 110, and scanning mirror 120. Likewise, green laser light produced by laser diode 104 is steered out the aperture by an optics system that includes mirror 105, filter/polarizer 110, and scanning mirror 120. Similarly, blue laser light produced by laser diode 106 is steered out the aperture by an optics system that includes mirror 107, filter/polarizer 110, and scanning mirror 120.

Mirrors 103, 105, and 107 are shown offset, or “biased,” to steer the various color laser beams to the scanning mirror on non-aligned paths. The result is an angular offset between color laser beams as they leave the aperture. This is shown at 140. The amount of angular offset may controlled by modifying the bias in the various optical systems. Different optical components may be translated or rotated in any fashion to achieve the desired amount of angular offset in the color laser beams. In some embodiments, the position of the laser diodes is changed to modify angular offsets between color laser beams. Laser diodes and/or optics systems may be biased in any fashion, separately or in combination, to modify the angular offsets between the color laser beams.

The angular offsets between laser beams reduce the amount of laser power incident on any single point. For example, at any given time, the red, green, and blue lasers will illuminate a different point in space, and the instantaneous laser power incident on any point is limited to the power produced by one laser beam. In some embodiments, the angular offsets are set to reduce the likelihood that more than one laser beam can enter a human eye at one time.

In some embodiments, a “minimum safety distance” is defined to be a distance from the projector beyond which a minimum spacing between the laser beams is ensured. For example, the minimum safety distance may be a distance from the projector at which the spacing between the color laser beams is greater than the diameter of a human eye pupil. In these embodiments, a human eye pupil illuminated at a distance greater than the minimum safety distance will not be illuminated by more than one laser beam at a time.

Some embodiments include a proximity detector to detect obstructions closer to the projector than the minimum safety distance, and shut down the laser beams when such an obstruction is detected. The combination of the angular offsets, the minimum safety distance and the proximity detector further reduce the likelihood that more than one laser beam will enter a human eye at any one time.

The MEMS based projector is described as an example, and the various embodiments of the invention are not so limited. For example, other projector types having angular offsets between projected laser beams may be substituted without departing from the scope of the present invention.

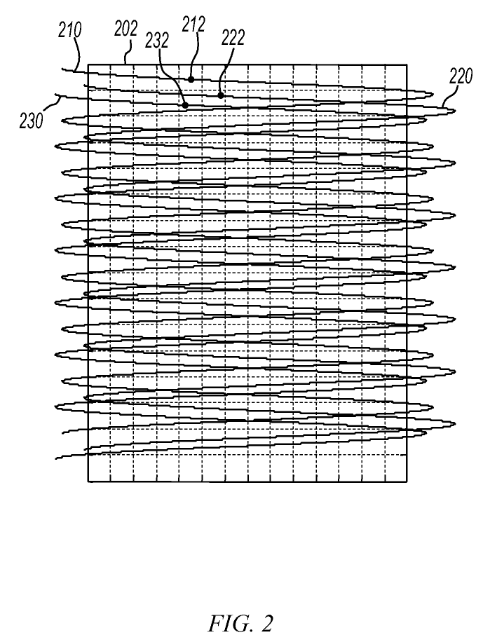

FIG. 2 shows scan trajectories having a sinusoidal horizontal component and a linear vertical component. Scan trajectories 210, 220, and 230 represent scan trajectories for three different color laser beams. For example, in some embodiments, scan trajectory 210 may be the trajectory of a red laser beam, scan trajectory 220 may be the trajectory of a green laser beam, and scan trajectory 230 may be the trajectory of a blue laser beam. Scan trajectories 210, 220, and 230 are shown superimposed upon a grid 202. Grid 202 represents rows and columns of pixels that make up a display image. The rows of pixels are aligned with the horizontal dashed lines, and columns of pixels are aligned with the vertical dashed lines. The image is made up of pixels that occur at the intersections of dashed lines.

Scan trajectories 210, 220, and 230 each have a sinusoidal horizontal component and a linear vertical component. On these trajectories, the color laser beams sweep back and forth left to right in a sinusoidal pattern, and sweep vertically at a constant rate. In some embodiments, the trajectories sweep up quickly during a “retrace” and pixels are not displayed on the retrace. In other embodiments, the trajectories sweep up linearly at the same rate as it swept down, and pixels are displayed during both up and down vertical sweeps.

Laser beam “spots” are shown at 212, 222, and 232. These three spots correspond to one possible placement of laser beams that results from the angular offsets described above (140, FIG. 1). For example, when the image is being displayed, laser beam spots 212, 222, and 232 may sweep back and forth generally following scan trajectories 210, 220, and 230 while displaying color. As shown in FIG. 2, offsets between laser beams may result in horizontal and/or vertical offsets.

As the color laser beams are swept along the scan trajectories, each laser beam is “painting” a different portion of the image because of the angular offsets between the beams. Accordingly, each of laser diodes 102, 104, and 106 (FIG. 1) are driven with pixel intensity data corresponding to different pixel locations within the image being displayed. Various embodiments of image generation/processing systems useful to source the correct pixel intensity data are described below with reference to FIG. 4.

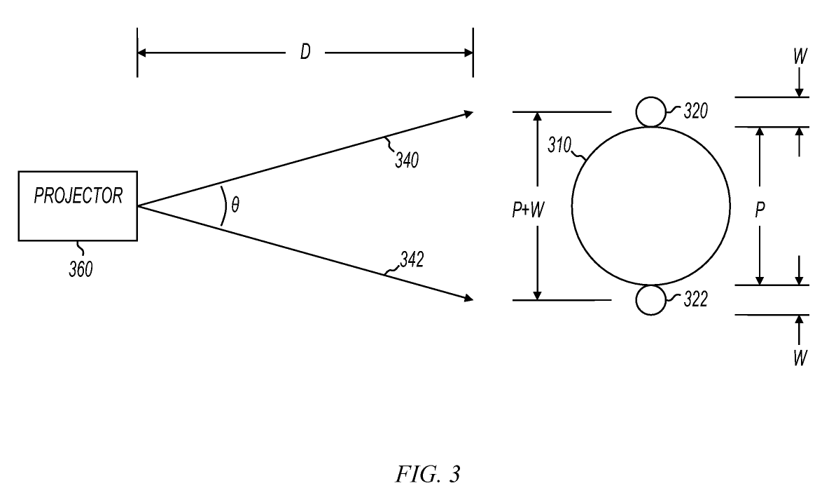

FIG. 3 shows a relationship between angular offsets and the size of a human eye. The circle at 310 represents the pupil of a human eye having a diameter P. The circles at 320 and 322 represent the spot size of laser beams, each having a diameter of W. Projector 360 projects laser beams 340 and 342 having an angular offset θ. Various embodiments of the present invention set the angle θ to different values based on the amount of laser light to be allowed in a human eye pupil of diameter P. For example, in some embodiments, the angle θ is set within the projector such that the spacing between the two laser beams is at least P+W at the minimum safety distance D. Further, in some embodiments, the angle θ is set within the projector such that the spacing between the two laser beams is at least P+0.5 W at the minimum safety distance D. In still further embodiments, the angle θ is set within the projector such that the spacing between the two laser beams is at least P.

Assuming that the angle θ results in a spacing of P+W at the minimum safety distance D, the angle θ and spacing P+W are related by

$$tan ( \frac{θ}{2} ) = \frac{P + W}{2 D} \qquad ( 1 )$$

For small angles θ, equation 1 becomes

$$θ = \frac{P + W}{D} \qquad ( 2 )$$

Assuming that P=7 mm, W=2 mm, and D=200 mm, then θ=0.45 radians or 2.6 degrees. For an 800×600 display with a horizontal field of view of 24 degrees, this gives a spacing between spots in the horizontal dimension of

$$\frac{800 \text{pixels}}{24 \text{degrees}} ( 2.6 \text{degrees} ) = 87 pixels \qquad ( 3 )$$

Referring now back to FIG. 2, if the width of grid 202 represents 800 pixels over a 24 degree field of view, then a 2.6 degree offset between beams will yield a spacing of about 87 pixels between spots 212, 222, and 232. Further, as long as the image is being displayed farther away than the minimum safety distance D, then the spacing of 87 pixels will keep more than one laser beam from entering a 7 mm pupil at one time.

The angular offset between the beams may be set by biasing optical components or laser light producing devices. For example, referring to FIG. 1, the position of mirrors 103, 105, and 107 may be modified until a 2.6 degree angular offset exists at 140. Further, the position of laser diodes 102, 104, and 106 may also be modified to achieve the desired angular offset.

The values for P, W, D, the field of view, and display size are provided above as examples, and are not meant to limit the invention in any way. Any suitable value(s) may be substituted without departing from the scope of the present invention. Further, in some embodiments, the minimum spacing between laser beam spots may be set for a reason other than protection of human eyes. In these embodiments, the spacing between laser beam spots may be significantly larger or smaller than the examples provided above.

FIG. 4 shows a projection device capable of processing display information for color laser beams having angular offsets. Projection device 400 includes image processing device 410, beam source/optics 480, sweep drive 490, and proximity detector 482. Image processing device 410 includes frame buffer 412, row buffer 422, horizontal scan position determination component 414, vertical scan position determination component 416, and interpolation component 424. In embodiments represented by FIG. 4, the projection device processes a color image, and three image processing devices 410 exist to process each of three colors (e.g., Red, Green, Blue).

Beam source/optics 480 projects multiple laser beams having angular offsets. In some embodiments, Beam source/optics 480 is implemented as micro-projector 100 (FIG. 1). Beam source/optics 480 receives pixel intensity data from image processing device 410, and produces color laser light accordingly.

In operation, sweep drive 490 provides signals to beam source 480 to cause color laser beams having angular offsets to scan a trajectory to paint a display image. The beam scan trajectory may take any form. For example, the scan trajectory may be linear in one direction and non-linear in another direction as shown in FIG. 2. Also for example, various embodiments exist with linear scan trajectories in both directions. Further, some embodiments of the present invention have non-linear trajectories in both vertical and horizontal directions. Any scan trajectory may be utilized, including arbitrary trajectories, without departing from the scope of the present invention.

Frame buffer 412 holds rows and columns of pixel data that make up the image to be displayed. In some embodiments, frame buffer 412 is periodically updated at a predetermined rate to support video display. Frame buffer 412 may be a row oriented memory device capable of quickly reading entire rows of pixel data. One or more rows of pixel data may be read from frame buffer 412 to row buffer 422 for further processing.

Image processing device 410 receives a pixel clock on node 402. The pixel clock may or may not be periodic. In some embodiments, the pixel clock is a periodic clock that provides edges at periodic intervals having a constant period. In embodiments having non-linear scan trajectories, the scan beam may or may not be at a position in the display image that corresponds to a pixel. The pixel clock is provided to horizontal scan position determination component 414 and vertical scan position determination component 416.

Each time a pixel clock edge arrives, horizontal scan position determination component 414 determines (or provides) the current horizontal position of the color laser beam within the displayed image. Similarly, each time a pixel clock edge arrives, vertical scan position determination component 416 determines (or provides) the current vertical position of the color beam within the displayed image. The current vertical and horizontal scan positions are provided to row buffer 422 and interpolation component 424. Row buffer 422 provides pixel data to component 424 which then interpolates between pixel data to determine the correct intensity for the color being processed.

Each image processing device 410 may independently determine the scan position of the corresponding color laser beam. For example, if the red laser beam is offset horizontally from the green laser beam by 87 pixels, then the horizontal scan position determination component for the red image processing device will report a scan position offset by 87 pixels from the green scan position. Vertical offsets are handled in a similar manner.

Horizontal scan position determination component 414 and vertical scan position determination component 416 may be implemented in any way. For example, components 414 and 416 may be implemented in dedicated hardware, software or any combination. In some embodiments, components 414 and 416 are implemented as look up tables. The look up tables are programmed with values that correspond to the scan trajectories that are offset as a result of the angular offsets between the color laser beams. Also for example, in some embodiments, components 414 and 416 evaluate mathematical functions to determine the scan positions at each pixel clock. Example mathematical function embodiments are provided below.

In embodiments corresponding to FIG. 2, a horizontal scan position may be determined at each pixel clock as

h=hₒ(c,y)sin(2πft+Φ(c,y))+B(c,y). (4)

As shown in equation (4), the horizontal scan position h may be determined as the sum of an offset B and a scaled sine of an increasing angle. The increasing angle is created because t advances for each pixel clock. The horizontal offset B is can be a function of any variable. In the example of equation (4), the horizontal offset B is a function of color c, and vertical position y. By making the horizontal offset B a function of color, angular offsets in the projected laser beams can be accommodated in the image processing circuitry.

As shown in equation (4), other types of offsets and scalings can be accommodated in the scan position determination components. For example, in some embodiments, the phase offset Φ is a function of one or both of the color being processed c, and the current vertical scan position y. Further, the sine function may be scaled by multiplier hₒ that is also a function of one or both of the color being processed c, and the current vertical position y. Multiplier hₒ provides normalization so that h has a value in pixels between the left and right edges of the image. For example, for an 800×600 display with 800 pixels in each row, h may have a range of 800. In some embodiments, the range may be greater than 800 to accommodate overscan regions beyond the displayed image. The horizontal scan position h is broken down into the integer portion n and the decimal portion α. For example, if h is determined to be 6.4, (between the sixth and seventh pixel), then n=6 and α=0.4.

The vertical scan position may be determined in a similar manner to the horizontal scan position described in the previous paragraphs. The vertical scan position determination may accommodate scaling and offsets to compensate for angular offsets between color laser beams. The vertical position v is broken down into the integer portion m and the decimal portion b. For example, if v is determined to be 9.8, then m=9 and b=8.

Row buffer 422 receives n and m and provides pixel intensity data for pixels P_{n,m}, P_{n,m+1}, P_{n+1,m}, and P_{n+1,m+1} to interpolation component 424. Interpolation component 424 interpolates between P_{n,m}, P_{n,m+1}, P_{n+1,m}, and P_{n+1,m+1} to determine the new pixel intensity P_{new} as

P_{new}=(1−α)(1−b)P_{n,m}+α(1−b)P_{n+1,m}+(1−α)bP_{n,m+1}+αbP_{n+1,m+1} (5)

Equation (5) is an example of linear interpolation between four pixels. The various embodiments of the invention are not limited to linear interpolation. For example, in some embodiments, nearest neighbor interpolation is used, and in other embodiments, higher order (e.g., cubic) interpolation is utilized. By performing equation (5) for each color, pixel intensity information can be determined for the current position of each color laser beam, which may differ because of the angular offset between projected laser beams.

Some embodiments of the present invention include proximity detector 482. Proximity detector 482 detects whether any object is closer than a threshold distance, and sends a “disable” signal to interpolation component 424. In some embodiments, proximity detector 482 detects whether an object in the path of the projected laser beam is closer than the minimum safety distance D (FIG. 2), and disables the laser outputs when one is found. By disabling the laser outputs when an object is found to be closer than the minimum safety distance, the likelihood of the lasers causing damage to human eyes can be reduced.

Proximity detector 482 can be implemented in any way. For example in some embodiments, proximity detector 482 is implemented as an infrared (IR) rangefinder. The technology used for proximity detector 482 is not a limitation of the present invention.

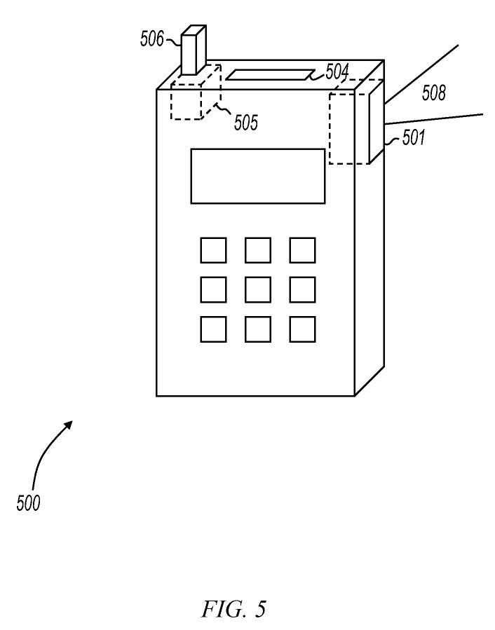

FIG. 5 shows a mobile device in accordance with various embodiments of the present invention. Mobile device 500 may be a hand held projection device with or without communications ability. For example, in some embodiments, mobile device 500 may be a handheld projector with little or no other capabilities. Also for example, in some embodiments, mobile device 500 may be a device usable for communications, including for example, a cellular phone, a smart phone, a personal digital assistant (PDA), a global positioning system (GPS) receiver, or the like. Further, mobile device 500 may be connected to a larger network via a wireless (e.g., WiMax) or cellular connection, or this device can accept data messages or video content via an unregulated spectrum (e.g., WiFi) connection.

Mobile device 500 includes laser projector 501 to create an image with light 508. The light 508 is provided by laser beams that exit an aperture in the housing for mobile device 500. Similar to other embodiments of projection systems described above, mobile device 500 may include a projector that projects color laser beams having an angular offset. The angular offset may be set to reduce the likelihood of damage to a human eye at a given distance from the projector. Further, projector 501 may include a proximity detector to shut down the projector if an obstruction is detected in the path of the laser beams closer than a specified distance.

In some embodiments, mobile device 500 includes antenna 506 and electronic component 505. In some embodiments, electronic component 505 includes a receiver, and in other embodiments, electronic component 505 includes a transceiver. For example, in GPS embodiments, electronic component 505 may be a GPS receiver. In these embodiments, the image displayed by laser projector 501 may be related to the position of the mobile device. Also for example, electronic component 505 may be a transceiver suitable for two-way communications. In these embodiments, mobile device 500 may be a cellular telephone, a two-way radio, a network interface card (NIC), or the like.

Mobile device 500 also includes memory card slot 504. In some embodiments, a memory card inserted in memory card slot 504 may provide a source for video data to be displayed by laser projector 501. Memory card slot 504 may receive any type of solid state memory device, including for example, Multimedia Memory Cards (MMCs), Memory Stick DUOs, secure digital (SD) memory cards, and Smart Media cards. The foregoing list is meant to be exemplary, and not exhaustive.

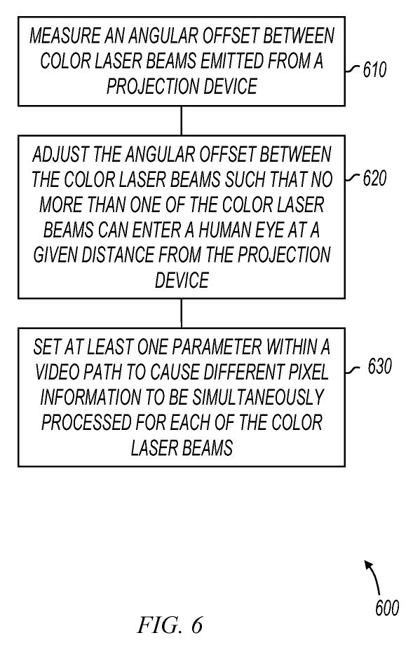

FIG. 6 shows a flowchart in accordance with various embodiments of the present invention. In some embodiments, method 600, or portions thereof, is performed by a laser projector, an image generation apparatus, a mobile projector, or the like, embodiments of which are shown in previous figures. In other embodiments, method 600 is performed by a calibration apparatus when a laser projector is manufactured. Method 600 is not limited by the particular type of apparatus performing the method. The various actions in method 600 may be performed in the order presented, or may be performed in a different order. Further, in some embodiments, some actions listed in FIG. 6 are omitted from method 600.

Method 600 is shown beginning with block 610 in which an angular offset between color laser beams emitted from a projection device is measured. In some embodiments, this measurement is made by a high speed camera as the color laser beams are scanning a trajectory to display an image. For example, referring now back to FIG. 2, the spacing between spots 212, 222, and 232 may be measured at a given distance from the projector. In some embodiments, this measurement is made by stopping the scan and directly measuring the spacing between spots.

At 620, the angular offset between the color laser beams is adjusted such that no more than one of the color laser beams can enter a human eye at a given distance from the projection device. The angular offset may be adjusted by biasing optical components within the projection device. For example, reflective surfaces such as mirrors 103, 105, and 107 may be biased to modify angular offsets at 140 (FIG. 1). Also for example, the orientation of laser diodes 102, 104, and 106 may be changed to modify the angular offsets.

At 630, at least one parameter within a video path is set to cause different pixel information to be simultaneously processed for each of the color laser beams. For example, referring now back to FIG. 4, parameters within horizontal scan position determination component 414 and vertical scan position determination component 416 may be modified to compensate for the angular offsets between color laser beams. In the example of equation (4) above, the offset B can be set differently for each color. By setting the offset B differently for each color, each image processing device 410 may simultaneously process different pixel information for each color.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. A projection device comprising:
a housing having an aperture through which light can pass;
a first laser light producing device to produce a first laser beam;
a second laser light producing device to produce a second laser beam;
a first optics system to steer the first laser beam through the aperture; and
a second optics system to steer the second laser beam through the aperture;
wherein at least one of the first and second optics systems is biased to create an angular offset between the first and second laser beams at the aperture.

2. The projection device of claim 1 wherein the angular offset is large enough to prevent the first and second laser beams from entering a pupil at a minimum safety distance.

3. The projection device of claim 1 wherein the first and second laser light producing devices produce light of different colors.

4. The projection device of claim 1 further comprising:
a third laser light producing device to produce a third laser beam; and
a third optics system to steer the third laser beam through the aperture, wherein the third laser beam has different angular offsets to the first and second laser beams at the aperture.

5. The projection device of claim 1 further comprising at least one scanning mirror to scan the first and second laser beams in a pattern to display an image.

6. The projection device of claim 5 wherein the at least one scanning mirror comprises a biaxial mirror to scan the first and second laser light beams in two dimensions.

7. The projection device of claim 5 further comprising an image generation apparatus to process different pixel information for each of the first and second laser beams.

8. A projection device comprising:
a housing having an aperture through which light can pass;
a first laser light producing device to produce a first laser beam;
a second laser light producing device to produce a second laser beam;
a first optics system to steer the first laser beam through the aperture; and
a second optics system to steer the second laser beam through the aperture;
wherein an orientation of at least one of the first and second laser light producing devices is biased to create an angular offset between the first and second laser beams at the aperture.

9. The projection device of claim 8 further comprising video processing circuitry to provide laser intensity information to each of the first and second laser light producing devices.

10. The projection device of claim 9 wherein the first laser beam is a first color and the second laser beam is a second color.

11. The projection device of claim 10 further comprising a scanning mirror to sweep the first and second laser beams in a pattern to display pixels in an image.

12. The projection device of claim 11 wherein the video processing circuitry includes separate scan position determination hardware for each of the laser beams.

13. An apparatus comprising:
a plurality of color laser light sources;
a scanning mirror to reflect color laser beams from the plurality of color laser light sources and to scan in a pattern to display pixels in an image; and
a plurality of reflective devices to direct the color laser beams from the plurality of color laser light sources to the scanning mirror, wherein the plurality of color laser light sources and the plurality of reflective devices are oriented to create a constant nonzero angular offset between color laser beams reflected by the scanning mirror.

14. The apparatus of claim 13 further comprising video processing circuitry to independently determine pixel display information for each of the color laser beams.

15. The apparatus of claim 14 further comprising an image buffer to hold pixel color information for each pixel in the image.

16. The apparatus of claim 15 further comprising means to retrieve pixel information from the image buffer independently for each color.

17. A mobile device comprising:
a communications transceiver; and
a projector to display an image by sweeping a plurality of color laser beams, wherein the plurality of color laser beams have angular offsets relative to each other, the angular offsets sufficient to keep more than one of the plurality of color laser beams from entering a human eye pupil at a minimum safety distance.

18. The mobile device of claim 17 further comprising a plurality of laser diodes and video processing circuitry to provide color intensity information to the plurality of laser diodes.

19. The mobile device of claim 17 further comprising a proximity detector coupled to the video processing circuitry to disable the plurality of laser diodes when an obstruction is detected nearer than the minimum safety distance.

20. A method comprising:
measuring an angular offset between color laser beams emitted from a projection device; and
adjusting the angular offset between the color laser beams to ensure no more than one of the color laser beams can enter a human eye at a given distance from the projection device.

21. The method of claim 20 wherein adjusting comprises altering a position of a laser diode.

22. The method of claim 20 wherein adjusting comprises altering a position of at least one reflective surface within the projection device.

23. The method of claim 20 wherein adjusting comprises setting the angular offset to a value that ensures a minimum distance between the laser beams at least as large as a human pupil diameter when measured at a predetermined distance from the projection device.

24. The method of claim 20 further comprising setting parameters within a video path to cause different pixel information to be simultaneously processed for each of the color laser beams.
